(19) United States
(12) Patent Application Publication
(10) Pub. No.: US 2008/0139431 A1
(43) Pub. Date: Jun. 12, 2008

(54) Very low voc compositions for removing substances from substrate surfaces

(76) Inventor: Herb Schreiber, Bedford Heights, OH (US)

Correspondence Address: SCHACHT LAW OFFICE, INC., SUITE 202, 2801 MERIDIAN STREET, BELLINGHAM, WA, 98225-2412, US

(21) Appl. No.: 11/985,398

(22) Filed: Nov. 14, 2007

Related U.S. Application Data
(60) Provisional application No. 60/859,387, filed on Nov. 15, 2006.

(51) Int. Cl. C11D 3/44; C11D 3/50

(52) U.S. Cl. 510/107; 510/407

(57) ABSTRACT

A remover composition comprises a primary solvent and at least one of a secondary solvent portion and an additive portion. The primary solvent portion has a K_{b} value of substantially between 25 and 40. The percentage by weight of primary solvent portion is within a primary solvent range of less than approximately 99% of the remover composition.

### RELATED APPLICATIONS

This application claims priority of U.S. Provisional Ser. No. 60/859,387 filed Nov. 15, 2006, the content of which are incorporated herein by reference.

### FIELD OF THE INVENTION

The present invention relates to the removal of substances from substrate surfaces and, more particularly, to compositions that, when applied to certain substances, alter the characteristics of the substances to facilitate removal of the substances from a variety of substrate surfaces.

### BACKGROUND OF THE INVENTION

The process of removing a substance that has been intentionally or unintentionally applied to a substrate surface is significantly simplified if the characteristics of the applied substance are altered. For example, removal of chewing gum from a carpet or fabric is simplified if the gum is softened or otherwise dissolved. Similarly, permanent ink can be wiped off of a painted surface more easily when dissolved into liquid form.

A number of remover compositions have been formulated to alter the characteristics of a variety of applied substances to facilitate removal of these applied substances from a variety of substrate surfaces. Ideally, such remover compositions typically comprise solvents that are formulated to break down the applied substance without permanently damaging the material defining the substrate surface.

Recently, however, various government entities have enacted regulations that effectively restrict the use of certain solvents in conventional remover compositions. This includes, but is not limited to, the weight percentage of Volatile Organic Compounds (VOC) used and several chlorinated solvents.

The need thus exists to develop new remover compositions that effectively alter the characteristics of a variety of applied substances to facilitate removal of these applied substances from a variety of substrate surfaces but which also meet governmental regulations.

### SUMMARY OF THE INVENTION

The present invention may be embodied as a remover composition comprising a primary solvent and at least one of a secondary solvent portion and an additive portion. The primary solvent portion has a K_{b} value of substantially between 25 and 40. The percentage by weight of primary solvent portion is within a primary solvent range of less than approximately 99% of the remover composition.

### DETAILED DESCRIPTION

The present invention may be embodied as a remover composition comprising materials that, when combined, provide a balance of characteristics that is desirable in a composition for removing a variety of applied substances from a variety of substrates.

A remover composition of the present invention comprises a primary solvent portion and a secondary solvent portion comprising at least one secondary solvent. Many typical applied substances are formed at least in part of organic materials, and the purpose of the primary and secondary solvent portions is to dissolve or otherwise loosen these organic materials.

A remover composition of the present invention may further comprise one or more additional components such as a fragrance portion comprising at least one fragrance, a colorant portion comprising at least one colorant, a gellant portion comprising at least one gellant material, and a surfactant. The fragrance portion may provide the remover composition with an aesthetically pleasing odor or, depending upon the solvents used, may cover up displeasing odors. The colorant portion provides a color to the remover composition. The gellant portion is a thixotropic agent that causes the remover composition to form a gel when applied to the substrate. The surfactant conventionally facilitates spreading of the remover composition.

The primary solvent portion, secondary solvent portion, and additional components that may be used to create a remover composition according to the principles of the present invention will each be discussed in further detail below.

### I. PRIMARY SOLVENT PORTION

The primary solvent portion is formed of a low vapor pressure volatile organic compound (LVP-VOC) having a Kauri-Butanol Value (K_{b} value) of substantially between 15 and 40. The California Air Regulatory Board (C.A.R.B.) uses the term “LVP-VOC” to define a particular class of chemical compounds or mixtures that contain at least one carbon atom and, among other possible physical attributes, vaporize very slowly at 20 degrees Celsius. The term “K_{b} value” refers to a number indicative of the solvency of a material and is measured using an industry standard test procedure.

The following Table A contains a list of materials that may be used, alone or in combination, as the primary solvent portion:

TABLE A

| Scientific Name | CAS number | Example Ingredient (Supplier) |
|---|---|---|
| Hydrotreated Light | 64742-47-8 | LVP 200 (Calumet Lubricants |
| Distillates (petroleum) | | Co.) |
| Hydrotreated Light | 64742-47-8 | LVP 100 (Calumet Lubricants |
| Distillates (petroleum) | | Co.) |
| | | Conosol C-200 (Penreco) |
| | | Isopar M (Exxon Mobile |
| | | Corporation) |
| | | Isopar V (Exxon Mobile |
| | | Corporation) |
| | 64771-72-8 | Norpar 15 (Exxon Mobile |
| | | Corporation) |
| Isoparaffinic | | |
| Hydrocarbons | | |
| Cycloparaffinic | | |
| Hydrocarbons | | |

### II. SECONDARY SOLVENT PORTION

The secondary solvent portion is formed of a solvent having a Kauri-Butanol Value (Kb value) of greater than 40. The following Table B contains a list of materials that may be used, alone or in combination, as the secondary solvent portion:

TABLE B

| Scientific Name | CAS number | Example Ingredient (Supplier) |
|---|---|---|
| 1-Methyl-4-(1- | 94266-47-4 | d-Limonene |
| methylethenyl) | | |
| cyclohexene | | |
| | | Citrus Terpenes |
| | | Orange Extractives |
| | | Citrus Extractives |
| | 8028-48-6 | Cold Pressed Orange Oil |
| Tripropylene Glycol | 25498-49-1 | |
| (Mono) Methyl Ether | | |
| (TPM) | | |
| Propylene based | | PM, DPM, PE, PNP, DPNP, |
| glycol ethers | | PNB, DPNB, TPNB, PTB |
| Ethylene based | | DM, DE, EB, DB |
| glycol ethers | | |
| Tertiary Butyl Acetate | 540-88-5 | TBAc |

### III. ADDITIONAL COMPONENTS

If used, the colorant portion can be any compatible dye or pigment material that results in the remover composition having a desirable color. One example material that may be used as the colorant portion is identified by the scientific names Perinone or Monoazo (CAS Number 6925-69-5) and ingredient name Pylakrome Orange Dye LX-10710.

If used, the fragrance portion can be any compatible fragrance material that results in the remover composition having a desirable fragrance. One or more of the following materials may be used as the fragrance portion: Amyl Acetate (Primary, mixed isomers), Pentyl Acetate (CAS Number 628-63-7), 2-Methyl Butyl Acetate (CAS Number 624-41-9), and Isoamyl Acetate (CAS Number 123-92-2).

It should be noted that certain of the secondary solvent materials listed above have aromatic properties that may eliminate the need for a separate fragrance material. Alternatively, it may be desirable to blend the fragrance of a separate fragrance material with the fragrance of the secondary solvent materials to obtain a unique, desirable, and/or recognizable blended fragrance.

If used, the gellant portion can be any compatible gel material that results in the remover composition having desirable body and thickness when applied to the substrate surface. The gel portion can provided to the remover composition one or more of the following desirable characteristics: inhibit dripping or running of the remover composition; inhibit drying of the remover composition before the solvent portions can adequately penetrate the applied substance; and/or improve the consistency of the remover composition during application. An example of a gel material suitable for use as the gel portion is Sylvagel 6100 (Arizona Chemical).

If used, the surfactant may be any compatible surfactant material that lowers the surface tension of the remover composition. By lowering the surface tension of the remover composition, the surfactant facilitates spreading of the remover composition. An example of a suitable surfactant is Tomodol.

### IV. EXAMPLE REMOVER COMPOSITIONS

The following examples list several formulations of remover compositions by percent weight of the ingredient materials:

### Example 1

| | First | Second | |
|---|---|---|---|
| Component (Ingredient) | Range | Range | Example |
| Primary Solvent Portion | >68.0 | 80.0-94.0 | 87.1 |
| (LVP 200) | | | |
| Secondary Solvent Portion I | 0-30.0 | 5.0-14.0 | 9.5 |
| (d-Limonene) | | | |
| Secondary Solvent Portion II | 0-20.0 | 1.0-5.0 | 3.0 |
| (TPM) | | | |
| Fragrance Portion (Amyl | 0-5.0 | 0.1-0.7 | 0.4 |
| Acetate) | | | |

### Example 2

| | First | Second | |
|---|---|---|---|
| Component (Ingredient) | Range | Range | Example |
| Primary Solvent Portion (LVP | >68.0 | 86.0-99.0 | 97.0075 |
| 200) | | | |
| Secondary Solvent Portion | 0-30.0 | 0.9-9.0 | 2.99 |
| (Cold Pressed Orange Oil) | | | |
| Colorant Portion (Pylakrome | 0-2 | 0.00001-0.1 | 0.0025 |
| Orange) | | | |

### Example 3

| | First | Second | |
|---|---|---|---|
| Component (Ingredient) | Range | Range | Example |
| Primary Solvent Portion (LVP | >68.0 | 80.0-94.0 | 87.4975 |
| 200) | | | |
| Secondary Solvent Portion I | 0-30.0 | 3.0-10.0 | 6.5 |
| (d-Limonene) | | | |
| Secondary Solvent Portion II | 0-20.0 | 1.0-5.0 | 3.0 |
| (Cold Pressed Orange Oil) | | | |
| Secondary Solvent Portion III | 0-5.0 | 1.0-3.0 | 3.0 |
| (TPM) | | | |
| Colorant (Pylakrome Orange | 0-1.0 | 0.0010-0.0040 | .0025 |
| (LX10710 Pylam)) | | | |

### Example 4

| | First | Second | |
|---|---|---|---|
| Component (Ingredient) | Range | Range | Example |
| Primary Solvent Portion (LVP | >75.0 | 89.0-99.0 | 94.9975 |
| 200) | | | |
| Secondary Solvent Portion I | 0-23.0 | 1.0-11.0 | 3.0 |
| (TPM) | | | |
| Secondary Solvent Portion II | 0-23.0 | 1.0-11.0 | 2.0 |
| (Citrus Boost) | | | |
| Colorant Portion (LX10710 | 0-1.0 | 0.0010-0.0040 | .0025 |
| Pylam) | | | |

### Example 5

| | First | Second | |
|---|---|---|---|
| Component (Ingredient) | Range | Range | Example |
| Primary Solvent | >60.0 | 85.0-99.0 | 92.89825 |
| Portion (LVP 200) | | | |
| Secondary Solvent | 0-20.0 | 1.0-9.0 | 3.0 |
| Portion I (TPM) | | | |
| Secondary Solvent | 0-20.0 | 1.0-6.0 | 2.0 |
| Portion II | | | |
| (Citrus Boost) | | | |
| Gellant Portion | 0.1-10.0 | 1.0-6.0 | 2.1 |
| (Sylvagel 6100) | | | |
| Colorant (Pylakrome | 0-1.0 | 0.00010-0.00500 | 0.00150 |
| Orange (LX10710 | | | |
| Pylam)) | | | |
| Colorant (Pylakrome | 0-1.0 | 0.00010-0.00050 | 0.00025 |
| Scarlet (LX-10048 | | | |
| Pylam)) | | | |

### Example 6

| | First | Second | |
|---|---|---|---|
| Component (Ingredient) | Range | Range | Example |
| Primary Solvent | >60.0 | 74.0-88.0 | 81.14825 |
| Portion (LVP 200) | | | |
| Secondary Solvent | 0-30.0 | 6.0-20.0 | 12.5 |
| Portion (d-Limonene) | | | |
| Surfactant (Tomodol) | 0-10.0 | 2.0-12.0 | 4.0 |
| Gellant Portion | 0.1-10.0 | 1.0-6.0 | 1.8 |
| (Sylvagel 6100) | | | |
| Fragrance/Solvent | 0-30.0 | 0.10-1.5 | 0.5 |
| (Concentrated | | | |
| Orange Oil) | | | |
| Fragrance (Ethyl | 0-5.0 | 0.01-0.10 | 0.05 |
| Butyrate) | | | |
| Colorant (Pylakrome | 0-1.0 | 0.00010-0.00500 | 0.00150 |
| Orange (LX10710 | | | |
| Pylam)) | | | |
| Colorant (Pylakrome | 0-1.0 | 0.00010-0.00050 | 0.00025 |
| Scarlet (LX-10048 | | | |
| Pylam)) | | | |

The scope of the present invention should be determined with respect to any claims appended hereto and not the foregoing detailed description.

What is claimed is:

1. A remover composition comprising:
a primary solvent portion having a K_{b} value of substantially between 25 and 40; and
at least one of a secondary solvent portion and an additive portion; wherein
the percentage by weight of primary solvent portion is within a primary solvent range of less than approximately 99% of the remover composition.

2. The remover composition as recited in claim 1, in which the primary solvent portion comprises at least one material selected from the group of materials consisting of hydrotreated light distillates, isoparaffinic hydrocarbons, and cycloparaffinic hydrocarbons.

3. The remover composition as recited in claim 1, in which the primary solvent portion comprises at least one ingredient selected from the group of ingredients consisting of LVP 200, LVP 100, Conosol C-200, Isopar M, Isopar V, and Norpar 15.

4. The remover composition as recited in claim 1, in which the secondary solvent portion comprises at least one ingredient selected from the group of ingredients consisting of d-Limonene, Citrus Terpenes, Orange Extractives, Citrus Extractives, Cold Pressed Orange Oil.

5. The remover composition as recited in claim 1, in which the secondary solvent portion comprises at least one material selected from the group of materials consisting of 1-Methyl-4-(1-methylethenyl) cyclohexene, tripropylene glycol (mono) methyl ether, propylene based glycol esthers, ethylene based glycol esthers, and tertiary butyl acetate.

6. The remover composition as recited in claim 1, in which the secondary solvent portion comprises at least one material selected from the group of propylene based glycol ethers consisting of PM, DPM, PE, PNP, DPNP, PNB, DPNB, TPNB, and PTB.

7. The remover composition as recited in claim 1, in which the secondary solvent portion comprises at least one material selected from the group of ethylene based glycol ethers consisting of DM, DE, EB, and DB.

8. The remover composition as recited in claim 1, in which the additive portion comprises at least one material selected from the group of materials consisting of fragrance materials, colorant materials, gel materials, and surfactant materials.

9. The remover composition as recited in claim 1, in which the additive portion comprises at least one fragrance material selected from the group of materials consisting of amyl acetate, pentyl acetate, 2-methyl butyl acetate, and isoamyl acetate.

10. The remover composition as recited in claim 1, in which the additive portion comprises at least one colorant material selected from the group of materials consisting of perinone and monoazo.

11. A remover composition comprising:
at least 68.0 percent by weight of a primary solvent portion; and
up to approximately 30.0 percent by weight of a secondary solvent portion.

12. A remover composition as recited in claim 11, further comprising up to approximately 2.0 percent by weight of a colorant portion.

13. A remover composition as recited in claim 11, in which:
the primary solvent portion is LVP 200; and
the first secondary solvent portion is cold pressed orange oil.

14. A remover composition comprising:
at least 68.0 percent by weight of a primary solvent portion;
up to approximately 30.0 percent by weight of a first secondary solvent portion; and
up to approximately 20.0 percent by weight of a second secondary solvent portion.

15. A remover composition as recited in claim 14, further comprising up to approximately 5.0 percent by weight of a fragrance portion.

16. A remover composition as recited in claim 14, in which:
the primary solvent portion is LVP 200;
the first secondary solvent portion is d-Limonene; and
the second secondary solvent portion is TPM.

17. A remover composition comprising:
at least 68.0 percent by weight of a primary solvent portion;
up to approximately 30.0 percent by weight of a first secondary solvent portion;
up to approximately 20.0 percent by weight of a second secondary solvent portion; and
up to approximately 5.0 percent by weight of a third secondary solvent portion.

18. A remover composition as recited in claim 17, further comprising up to approximately 1.0 percent by weight of a colorant portion.

19. A remover composition as recited in claim 17, in which:
the primary solvent portion is LVP 200;
the first secondary solvent portion is d-Limonene;
the second secondary solvent portion is cold pressed orange oil; and
the third secondary solvent portion is TPM.

20. A remover composition comprising:
at least 75.0 percent by weight of a primary solvent portion;
up to approximately 23.0 percent by weight of a first secondary solvent portion; and
up to approximately 23.0 percent by weight of a second secondary solvent portion.

21. A remover composition as recited in claim 20, further comprising up to approximately 1.0 percent by weight of a colorant portion.

22. A remover composition as recited in claim 20, in which:
the primary solvent portion is LVP 200;
the first secondary solvent portion is TPM; and
the second secondary solvent portion is Citrus Boost.

23. A remover composition comprising:
at least 60.0 percent by weight of a primary solvent portion;
up to approximately 20.0 percent by weight of a first secondary solvent portion;
up to approximately 20.0 percent by weight of a second secondary solvent portion; and
substantially between 0.1 and 10.0 percent by weight of a gellant portion.

24. A remover composition as recited in claim 23, further comprising:
up to approximately 1.0 percent by weight of a first colorant portion; and
up to approximately 0.0 and 1.0 percent by weight of a second colorant portion.

25. A remover composition as recited in claim 23, in which:
the primary solvent portion is LVP 200;
the first secondary solvent portion is TPM;
the second secondary solvent portion is Citrus Boost; and
the gellant portion is Sylvagel 6100.

26. A remover composition comprising:
at least 60.0 percent by weight of a primary solvent portion;
up to approximately 30.0 percent by weight of a secondary solvent portion; and
substantially between 0.1 and 10.0 percent by weight of a gellant portion.

27. A remover composition as recited in claim 26, further comprising up to approximately 10.0 percent by weight of a surfactant.

28. A remover composition as recited in claim 26, further comprising up to approximately 30.0 percent by weight of concentrated orange oil.

29. A remover composition as recited in claim 26, further comprising:
up to approximately 1.0 percent by weight of a first colorant portion; and
up to approximately 1.0 percent by weight of a second colorant portion.

30. A remover composition as recited in claim 26, in which:
the primary solvent portion is LVP 200;
the secondary solvent portion is d-Limonene; and
the gellant portion is Sylvagel 6100.
